(19) United States
(12) Patent Application Publication
(10) Pub. No.: US 2016/0288069 A1
(43) Pub. Date: Oct. 6, 2016

(54) NAIL POLISH MIXING DEVICE

(71) Applicants: Ann Jasperson, Stamford, CT (US); James Ferro, Shelton, CT (US)

(72) Inventors: Ann Jasperson, Stamford, CT (US); James Ferro, Shelton, CT (US)

(21) Appl. No.: 14/678,103

(22) Filed: Apr. 3, 2015

(51) Int. Cl. B01F 13/08

(52) U.S. Cl. CPC B01F 13/08

(57) ABSTRACT

A portable mixing device may include a base that has a retention wall defining a recess and a driver that includes a driving magnet. The portable mixing device may further include a mixing chamber that can be positioned into the recess and removed therefrom. The mixing chamber may also include a mixing element with a footing, a paddle and a mixing magnet. The mixing magnet may magnetically couple to the driving magnet of the driver to induce rotation of the mixing element in the mixing chamber.

### BACKGROUND

Products such as nail polish or other cosmetics are often offered by manufacturers and retailers in a variety of types and colors in order to meet the needs of consumers in the marketplace. The various types and colors are typically produced by manufacturers in advance and then distributed to retail stores or offered to consumers through other distribution channels. This can lead to rows and rows of products sitting on shelves and large quantities being held in inventory. This also requires manufacturers and retailers to attempt to predict the needs of consumers. This can be cumbersome because of the ever-changing state of fashion and the wide variety of preferences and needs of consumers.

Therefore, there exists in the marketplace a need to provide a wide assortment of cosmetics, such as nail polish, to consumers in the marketplace without the drawbacks of present methods and practices. The present disclosure describes a device and method of use that permits a consumer or a retailer to create a vast assortment of cosmetics, including nail polishes, that can be prepared according the specific needs of a consumer without the disadvantages associated with traditional methods of distribution and manufacturing.

The present disclosure provides, in one example, a mixing device that permits the creation of customized cosmetics without the need for specialized or cumbersome manufacturing equipment.

In another example, the present disclosure provides a mixing device that can efficiently and effectively mix a variety of different materials and additives.

It is still another example the present disclosure describes a mixing device that permits the mixing of the contents of a container without the need to add or remove any components such that the process is cleaner than and presents less risk of contamination than known mixing devices and methods.

### BRIEF SUMMARY

In one embodiment of the present disclosure a portable mixing device includes a base with a retention wall defining a recess. The base also includes a driver with a driving magnet. In the recess, the portable mixing device includes a mixing chamber with a mixing element that includes a footing, a paddle and a mixing magnet. The mixing element is magnetically coupled to the driver to induce rotation of the mixing element.

In another embodiment the footing of the portable mixing device may include a peripheral surface that is located adjacent an inner surface of an enclosure of the mixing chamber. The peripheral surface maintains the mixing element's central position inside the enclosure.

In another embodiment the base of the portable mixing device may also include an activation switch located in the recess that activates the driver when the mixing chamber is positioned inside the recess.

In still another embodiment, the portable mixing device may include a collar that fits within the recess that includes a border that defines a pocket. The pocket is smaller in volume than the recess such that different size mixing chambers can be used with the base.

In still another embodiment, the mixing chamber of the portable mixing device is a nail polish container that includes a lid and a brush.

In another embodiment, the driver of the portable mixing device may be located in a central position in the bottom of the recess and be made of a low-friction material such that when the mixing chamber is positioned and held in the recess, the driver can spin and induce the mixing element to spin in order to mix the contents of the mixing chamber.

In another example of the present disclosure, a mixing chamber may include a mixing element with a footing, a paddle and a mixing magnet. the mixing chamber may also include an enclosure with a floor in which the mixing element can be removably positioned. The mixing chamber may also include a cap that can be secured to the top edge of the enclosure.

In another example, the footing of the mixing chamber is disc-shaped and the paddles are perpendicular to the footing.

In an example method of the present disclosure, a method of mixing nail polish may include adding a color component to a nail polish mixture inside an enclosure of a mixing chamber that includes a mixing element. The method also includes the steps of positioning the mixing chamber inside a recess of a base that includes a driver and mixing the color component and the nail polish mixture by causing the driver to spin the mixing element by magnetic coupling of the driver and the mixing element. The method may also include removing the mixing chamber from the base.

In another example method, a user may also actuate a motor connected to the driver by pressing the mixing chamber on an actuation switch inside the recess of the base.

### BRIEF DESCRIPTION OF THE SEVERAL VIEWS OF THE DRAWINGS

Certain embodiments are shown in the drawings. However, it is understood that the present disclosure is not limited to the arrangements and instrumentality shown in the attached drawings, wherein:

FIG. 1 is an illustration of one embodiment of a mixing device of the present disclosure.

FIG. 2 is an exploded view of the embodiment shown in FIG. 1.

FIG. 3 is an illustration of one embodiment of a mixing chamber of the present disclosure.

FIG. 4 is an illustration of one embodiment of a nail polish container of the present disclosure.

FIG. 5 is an illustration of one embodiment of a base of the present disclosure.

FIG. 6 is an exploded view of one embodiment of a mixing chamber of the present disclosure.

FIG. 7 is an illustration of one embodiment of a mixing element of the present disclosure.

FIG. 8 is an illustration of another embodiment of a mixing element of the present disclosure.

FIG. 9 is an illustration of another embodiment of a mixing element of the present disclosure.

FIG. 10 is an illustration of another embodiment of a mixing element of the present disclosure.

FIG. 11 is an illustration of another embodiment of a mixing element of the present disclosure.

FIG. 12 is an illustration of another embodiment of a mixing element of the present disclosure.

FIG. 13 is an illustration of another embodiment of a mixing element of the present disclosure.

FIG. 14 is an illustration of another embodiment of a mixing element of the present disclosure.

FIG. 15 is an illustration of another embodiment of a mixing element of the present disclosure.

FIG. 16 is an illustration of another embodiment of a mixing element of the present disclosure.

FIG. 17 is an illustration of another embodiment of a mixing element of the present disclosure.

### DETAILED DESCRIPTION

For the purposes of promoting and understanding the principles disclosed herein, references are now made to the preferred embodiments illustrated in the drawings and specific language is used to describe the same. It is nevertheless understood that no limitation of the scope of the invention is thereby intended. Such alterations and further modifications in the illustrated device and such further applications of the principles disclosed as illustrated herein are contemplated as would normally occur to one skilled in the art to which this disclosure relates.

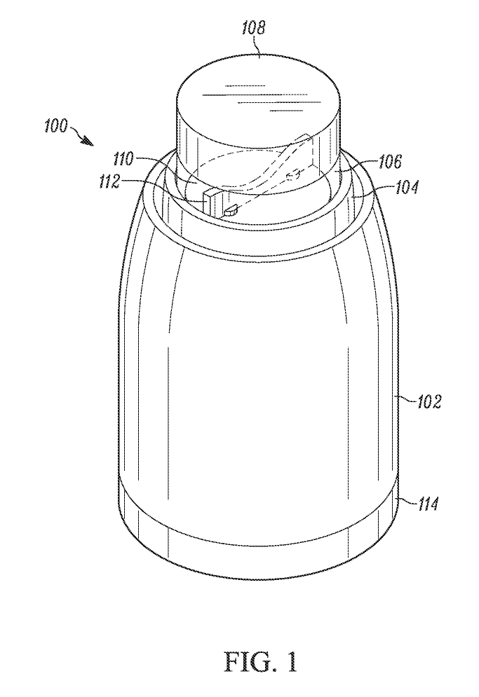

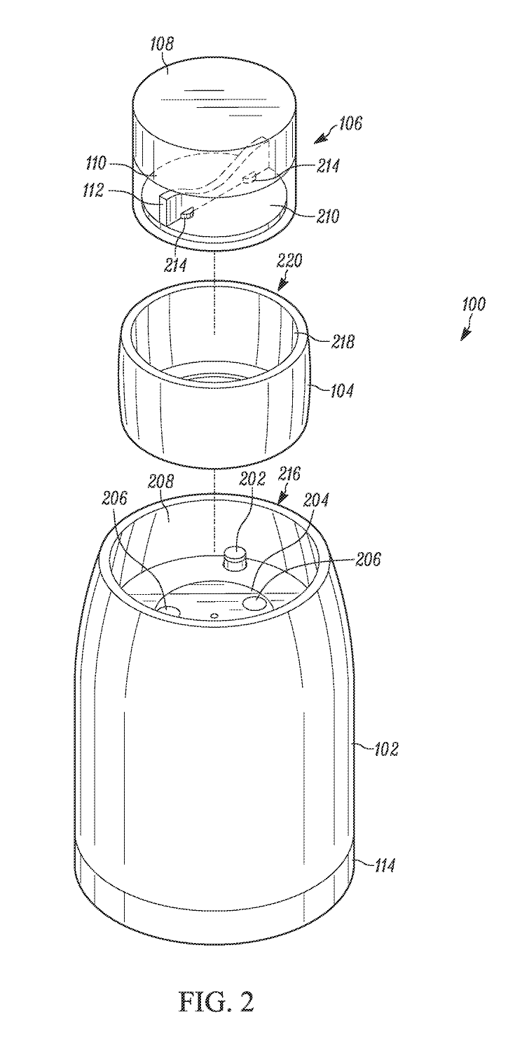

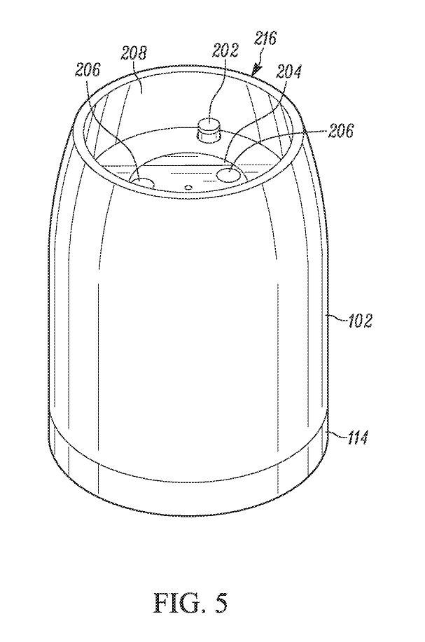

One embodiment of a nail polish mixing device is shown in FIG. 1. The mixing device 100 may include base 102, collar 104, mixing chamber 106, cap 108, mixing element 110 and paddle 112. As further shown in FIGS. 2 and 5, mixing chamber 106 fits into base 102 and base 102 includes driver 204. Driver 204 is coupled to a motor (not shown) that is housed inside of base 102 that spins driver 204 and in turn, mixes the contents of mixing chamber 106 as will be further explained. Base 102, in this example, is generally cylindrical in shape with a tapered portion toward the top. Base 102 can, however, be of any suitable size and shape that can hold the motor, electronic circuitry, power source and other required elements to provide the functionality as will be described. In one example, base 102 is an injection molded plastic component with a removable pedestal 114. Pedestal 114 can be removed in whole from base 102 or include a door or other access point in order to provide access to the internal components of base 102. In other examples, base 102 can be made of metals, alloys or other composite materials.

Referring back to FIGS. 2 & 5, base 102 may also include activation switch 202, driver 204, and retention wall 208. In this embodiment, base 102 includes upstanding retention wall 208 that defines recess 216. When in use during the mixing process, mixing chamber 106 is placed inside recess 216 and is surrounded by retention wall 208. The bottom of recess 216 may be a circularly-shaped flat surface as shown in FIG. 5. In this embodiment, the bottom of recess 216 includes both the stationary annular portion that extends from the outer edge of the bottom that meets circularly-shaped driver 204. In this arrangement, the stationary annular portion of the bottom of recess 216 and the surface of driver 204 define a substantially co-planar surface on which mixing chamber 106 can be placed.

As further shown in FIG. 5, activation switch 202 can be positioned near the outer edge the bottom of recess 216. Activation switch 202 can be any suitable toggle switch that is coupled to the motor and other electrical circuitry inside of base 102 such that when mixing chamber 106 is inserted into recess 216 and a force is applied in a downward direction, driver 204 spins and in turn, the contents of mixing chamber 106 are mixed.

Mixing device 100 may also include collar 104. Collar 104, as shown in FIG. 2, in an element configured to be received in recess 216 of base 102. In instances where the outer diameter of mixing chamber 106 is significantly smaller than the inner diameter of recess 216, collar 104 can be used to occupy the space that otherwise would exist. Collar 104 maintains mixing chamber 106 in a substantially centralized position in recess 216 so that driver 204 and mixing element 110 are aligned. In instances where mixing chamber 106 is larger and the outer diameter of mixing chamber 106 is only slightly smaller than the inner diameter of recess 216 there is no need for collar 104. As can be seen in the example in FIG. 2, collar 104 may include border 218 that defines pocket 220. In this example, collar 104 is a cylindrically-shaped element and border 218 is an upstanding wall configured to receive a complimentary sized mixing chamber 106. Collar 104 can be made of any suitable material such as a metal, plastic, composite or the like.

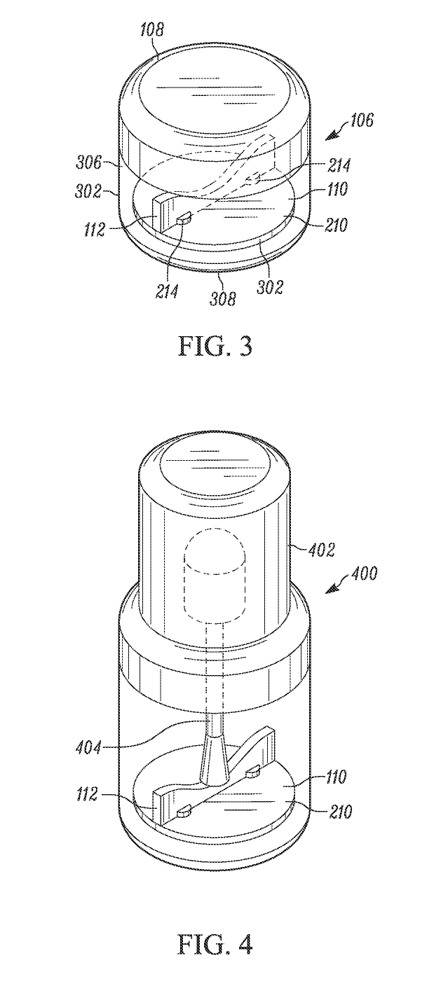

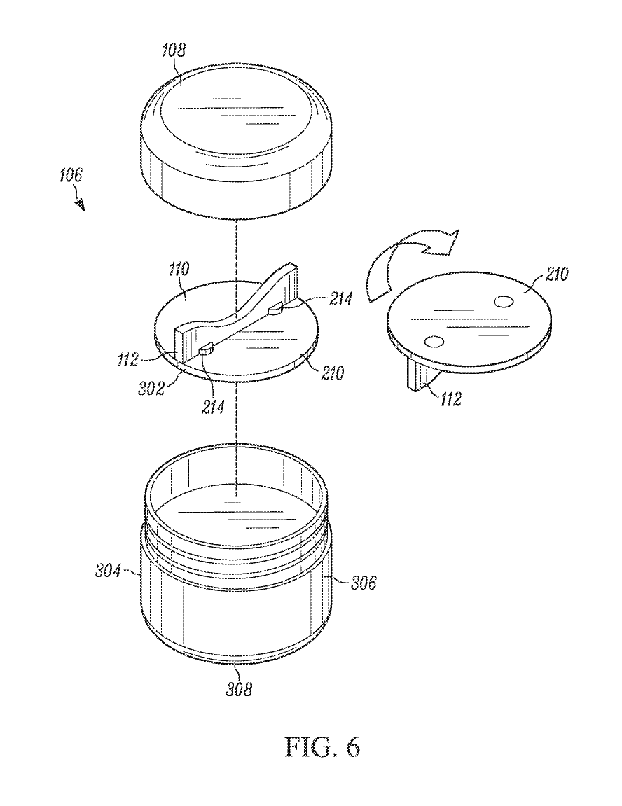

FIGS. 3 and 6 show one embodiment of mixing chamber 106. Mixing chamber 106 may also include cap 108 and mixing element 110. Mixing chamber 106 can be any suitable enclosure that can be used to hold the mixture of components that are to be mixed, such as nail polish and additives. As shown, mixing chamber 106 is cylindrically shaped with a threaded top on which cap 108 can be secured.

Mixing chamber 106 may also include mixing element 110. In one embodiment, mixing element 110 fits inside enclosure 206 of mixing chamber 106. In this embodiment, mixing element 110 includes footing 210, paddle 212 and mixing magnet 214. Footing 210 may be a disc-shaped horizontal element that is the base platform of mixing element 110 from which vertical paddle 112 is secured. As can be appreciated, as footing 210 spins around its center, paddle 112 mixes the mixture with any additives that may be present in enclosure 306. In order to maintain mixing element 110 in a central position in enclosure 306, the peripheral surface 302 of footing 210 has a smaller outer diameter than that of enclosure 306 defined by inner surface 304. In this embodiment, mixing chamber 106 has a consistent outer diameter such that mixing element 110 can be easily inserted and removed from mixing chamber 106 as shown in the exploded view in FIG. 6. Other profiles of mixing chamber 106 can also be used.

A second embodiment of mixing chamber 106 is shown in FIG. 4. As shown, mixing chamber 106 is nail polish container 400. In this embodiment, mixing element 406 is similar to the mixing element previously described such that is can be interchangeable with different style mixing chambers. Nail polish container 400 includes lid 402 with brush 404 connected thereto. Nail polish container 400 is configured so as to be inserted into base 102 for the mixing of custom nail polishes. The included lid 402 and brush 404 permits the user to mix a custom nail polish and then easily apply the custom polish without the need to transfer the polish between containers.

As described above, the mixing element 110 of mixing chamber 106 may also include mixing magnet 214. In one embodiment, mixing element 110 includes two mixing magnets 214 positioned diametrically across from each other under paddle 212. In this embodiment mixing magnets 214 are disc-shaped magnets attached through footing 210 such that they extend through footing 210 as shown in FIG. 6. Other configurations of mixing element 110 may also be used that use different shapes for mixing magnet 214 and different quantities of mixing magnets 214. As shown in FIG. 6, mixing magnet may be a single bar magnet that extends across footing 910. As shown in FIG. 8 and in FIG. 10, mixing element 110 may include three or four mixing magnets respectively.

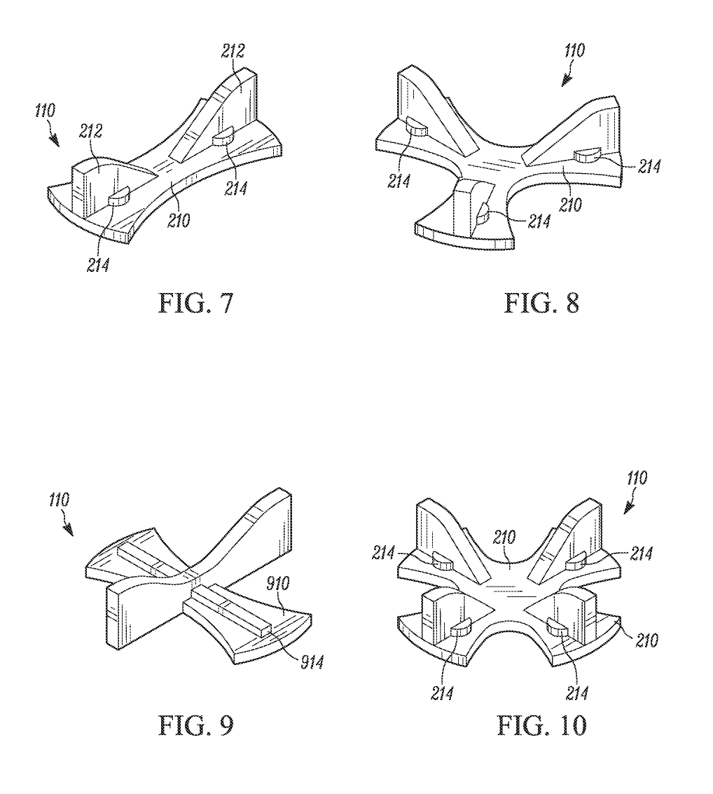

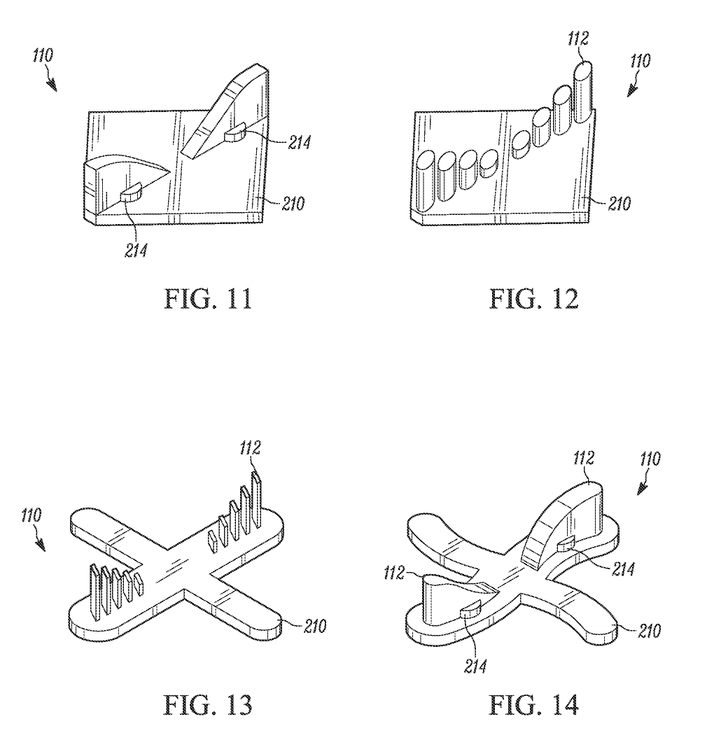

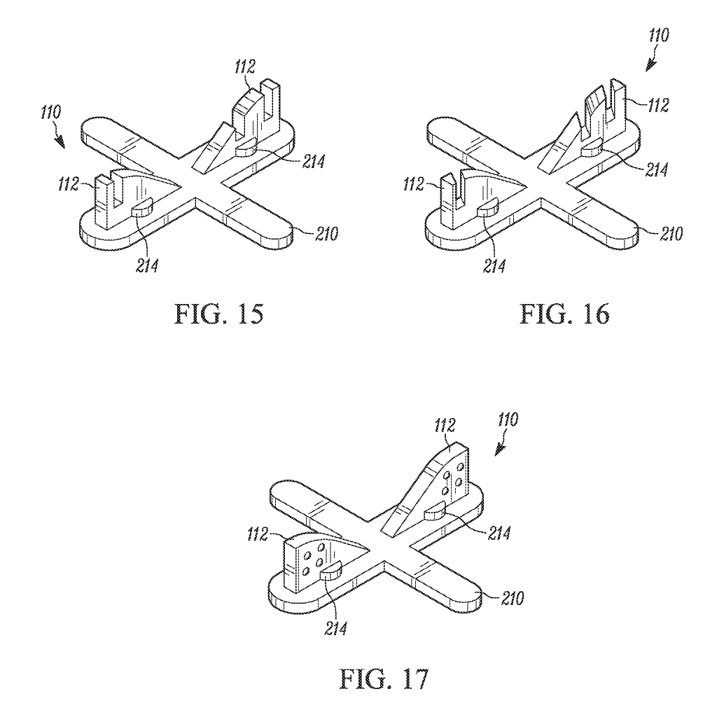

Mixing element 110 may also include different profiles and shapes of paddle 212. Paddle 212 may include a single double-fin shaped profile as shown in FIG. 6 or may include other profiles. FIGS. 7-17 show various profiles and arrangements of paddle 112. The different profiles of paddle 112 and of footing 210 and of mixing magnets 214 provide different advantages such as mixing efficiency, ease of manufacture, compatibility with different mixing chambers, stability, and compatibility with different mixtures of various viscosities.

As discussed above, driver 204 includes a driving magnet 206 and mixing element 110 includes a mixing magnet 214. The driving magnet 206 and the mixing magnet 214 are matched with each other such that when the mixing chamber 106 with mixing element 110 contained inside is place in base 102, the matched driving magnet 206 of driver 204 in base 102 couples with the mixing magnet 214. In this manner, when driver 204 spins, the magnetic coupling of the magnets induces mixing element 110 to spin inside of mixing chamber 106. Other configurations of mixing magnet 214 and driving magnet 206 can be used so long as the arrangement causes mixing element 110 to spin inside of mixing chamber 106 to mix the mixture and additives.

As shown in FIG. 2, when mixing chamber 106 is inserted into base 102, at least a portion of floor 308 of mixing chamber 106 sits on top of driver 204. In addition, mixing element 110 sits on top of floor 308 inside of enclosure 306. In order to permit the movement of both driver 204 and mixing element 110 relative to mixing chamber 106, these two component, in one embodiment, are made of a low-friction material. This permits these component to spin in their respective locations relative to mixing chamber 106. In one example, driver 204 and mixing element 110 are made of nylon material. Other materials with low-friction properties can also be used.

As discussed above, base 102 may include a motor, power source and other elements that spin driver 204. In other embodiments, base 102 may include gearing and mechanical coupling to driver 204 whereby a hand crank or other manual movements of a user can be used to spin driver 204 and in turn, spin mixing element 110.

In still other embodiments, base 102 may include a programmable logic controller (PLC) or hardware or software that can be used to control the speed, direction and time that driver 204 is induced to spin. Various spin profiles can be created and stored for use in different situation and for use with different liquids, cosmetics and materials. In one example, the PLC is programmed to spin automatically spin at a certain rate for a specified length of time and then to reverse and spin at the certain rate for a second specified length of time. The PLC then stops movement of driver 204 until the spin profile is started again. In other examples, an external control mechanism such as a cell phone or other device can be used to interact, store and program the PLC for further customization of the spin profiles.

Mixing device 100 can be used to mix a variety of different materials. One example use, as briefly discussed earlier, is in connection with a custom nail polish. A base nail polish can be mixed with different color elements, with textures, and with other additives, such as glitter, to obtain custom nail polish. The mixing device can also be used to mix paints and other cosmetic products such as, but not limited to, lotions, perfumes, lip gloss, creams and the like.

Various methods of mixing cosmetics are contemplated in the present disclosure. In one example method, a mixing element 110 is inserted into mixing chamber 106. A user could then deposit a certain quantity of a base nail polish into mixing chamber 106. A color component could then be added to the base nail polish. In addition, glitter or some other textured component could also be added. Mixing chamber 106 with the base nail polish and additives can then be inserted into recess 216 of base 102. When a force is applied to mixing chamber 106, activation switch 202 is depressed that. in turn, activates driver 204 to spin with a spin profile according to a user's choosing. The magnetic coupling between driver 204 and mixing element 110 induces mixing element 110 to also spin according to the spin profile. When the mixing is complete, driver 204 automatically stops or a user would cease applying a force to mixing chamber 106 to deactivate activation switch 202. The mixing chamber 106 could then be removed from base 102 and the mixed nail polish would be ready for use.

Other methods could also be employed to use mixing device 100. Other example methods could include a variation of the steps described above or involve performing the steps above in a different order.

While the particular preferred embodiments have been shown and described, it is obvious to those skilled in the art that changes and modifications may be made without departing from the teaching of the disclosure. The matter set forth in the foregoing description and accompanying drawings is offered by way of illustration only and not as limitation. The actual scope of the disclosure is intended to be defined in the following claims when viewed in their proper perspective based on the related art.

1. A portable mixing device comprising:
a base including a retention wall defining a recess and a driver with a driving magnet; and
a mixing chamber removably positioned in said recess, said mixing chamber including a mixing element with a footing, a paddle and a mixing magnet, wherein said mixing element is magnetically coupled to the driver to induce rotation of said mixing element.

2. The portable mixing device of claim 1 wherein said footing of said mixing element includes a peripheral surface positioned adjacent an inner surface of an enclosure of said mixing chamber in order to maintain said mixing element in a central position inside said enclosure.

3. The portable mixing device of claim 1 wherein said base further includes an activation switch positioned adjacent said driver inside said recess that activates said driver when said mixing chamber is positioned inside the recess.

4. The portable mixing device of claim 1 further comprising a collar that fits within said recess, said collar including a border defining a pocket, wherein the pocket is smaller in volume than the recess such that different size mixing chambers can be used with said base.

5. The portable mixing device of claim 1 wherein said mixing chamber is a nail polish container that includes a lid and a brush.

6. The portable mixing device of claim 1 wherein said driving magnet and said mixing magnet are disc-shaped.

7. The portable mixing device of claim 1 wherein said driver is circular and is centrally positioned in a bottom of said recess.

8. The portable mixing device of claim 1 wherein said driver contacts a floor of an enclosure of said mixing chamber during mixing.

9. The portable mixing device of claim 1 wherein said paddle is perpendicular to said footing.

10. The portable mixing device of claim 1 wherein said driver is made of a low-friction material to permit said driver to spin said mixing element when in contact with a floor of an enclosure of said mixing chamber.

11. The portable mixing device of claim 1 wherein said mixing element is removable from said mixing chamber.

12. A mixing chamber comprising:
a mixing element including a footing, a paddle and a mixing magnet;
an enclosure including a floor configured to removably receive said mixing element; and
a cap secured to a top edge of said enclosure.

13. The mixing chamber of claim 12 wherein said footing includes a peripheral surface that is located adjacent an inner surface of said enclosure to maintain said mixing element in a central position inside said enclosure.

14. The mixing chamber of claim 12 wherein said footing is disc-shaped and said paddles are perpendicular to said footing.

15. The mixing chamber of claim 12 further comprising a brush connected to said cap.

16. The mixing chamber of claim 12 wherein the enclosure is configured to be received in a base with a driver such that said mixing element is induced to spin in response to said driver against said floor of said enclosure.

17. The mixing chamber of claim 12 further comprising nail polish and additive components that create a custom nail polish when mixed.

18. A method mixing nail polish comprising:
adding a color component to a nail polish mixture inside an enclosure of a mixing chamber, wherein the mixing chamber includes a mixing element;
positioning said mixing chamber inside a recess of a base, said base comprising a driver;
mixing said color component and said nail polish mixture by causing said driver to spin said mixing element by magnetic coupling of said driver and said mixing element; and
removing said mixing chamber from said base.

19. The method of claim 18 further comprising:
actuating a motor connected to said driver by pressing said mixing chamber on an actuation switch located in said recess.

20. The method of claim 18 further comprising:
holding said mixing chamber inside said recess while said driver spins said mixing element.
